(19) United States
(12) Patent Application Publication
(10) Pub. No.: US 2016/0238408 A1
(43) Pub. Date: Aug. 18, 2016

(54) Automatic Determination of User Direction Based on Direction Reported by Mobile Device

(71) Applicant: Plantronics, Inc., Santa Cruz, CA (US)

(72) Inventors: Ken Kannappan, Palo Alto, CA (US); Douglas K. Rosener, Santa Cruz, CA (US)

(73) Assignee: Plantronics, Inc., Santa Cruz, CA (US)

(21) Appl. No.: 14/625,274

(22) Filed: Feb. 18, 2015

(51) Int. Cl. G01C 25/00

(52) U.S. Cl. CPC G01C 25/00

(57) ABSTRACT

Wearable electronic devices having corresponding apparatus and methods comprise: a direction sensor configured to determine directions of the electronic device; and a transmitter configured to transmit indications of the directions; wherein a calibration offset angle is determined between one of the directions of the electronic device and a direction of motion of the electronic device; and wherein a corrected device direction of the electronic device is determined based on the calibration offset angle and a subsequent direction of the electronic device.

### FIELD

The present disclosure relates generally to the field of navigation. More particularly, the present disclosure relates to determining a direction using data produced by sensors in mobile electronic devices.

### BACKGROUND

Currently many mobile electronic devices include sensors that may be used for navigation. Such devices include smartphones and wearables such as headsets. Many of these devices include electronic compasses that report a direction of the device. These compasses typically require an accelerometer to sense orientation in order to calibrate properly because the earth's magnetic field is generally not tangential to the earth's surface. These devices often include a gyroscope as well to aid in detection of rapid changes in orientation. In some cases, the gyroscope is used instead of a magnetometer. In these cases a relative direction is known, but not the true direction. Some of these devices include a GPS unit or the like. Such units provide position only, and perhaps direction of motion of the device if motion is tracked.

However, the direction of the device does not necessarily represent the direction of the user. For example, a compass in a smartphone will not correctly indicate the user direction unless the user points the device directly ahead.

### SUMMARY

In general, in one aspect, an embodiment features a wearable electronic device comprising: a direction sensor configured to determine directions of the electronic device; and a transmitter configured to transmit indications of the directions; wherein a calibration offset angle is determined between one of the directions of the electronic device and a direction of motion of the electronic device; and wherein a corrected device direction of the electronic device is determined based on the calibration offset angle and a subsequent direction of the electronic device.

Embodiments of the wearable electronic device may include one or more of the following features. Some embodiments comprise a receiver configured to receive an indication of the corrected device direction of the electronic device; and an output device configured to report the corrected device direction of the electronic device to a user of the electronic device. In some embodiments, the wearable electronic device comprises a headset; and the corrected device direction represents an orientation of a head of a wearer of the headset. Some embodiments comprise a don/doff sensor configured to indicate when the wearable electronic device is being worn; wherein the calibration offset angle and the corrected device direction are determined based only on directions determined by the direction sensor when the wearable electronic device is being worn. Some embodiments comprise a location sensor configured to determine a plurality of locations of the wearable electronic device; and a processor configured to determine the direction of motion of the wearable electronic device based on the plurality of locations of the wearable electronic device. Some embodiments comprise a motion sensor configured to determine a motion of the wearable electronic device; and a processor configured to determine the direction of motion of the wearable electronic device based on the motion of the wearable electronic device.

In general, in one aspect, an embodiment features an apparatus comprising: a processor configured to (i) determine a direction of motion of an electronic device; (ii) determine a calibration offset angle between the direction of motion and a first direction of the electronic device; and (iii) determine a corrected device direction of the electronic device based on the calibration offset angle and a second direction of the electronic device, wherein the second direction is determined subsequent to the first direction being determined.

Embodiments of the apparatus may include one or more of the following features. Some embodiments comprise a direction sensor configured to determine the first and second directions of the electronic device. Some embodiments comprise a location sensor configured to determine a plurality of locations of the electronic device; wherein the processor is further configured to determine the direction of motion of the electronic device based on the plurality of locations of the electronic device. Some embodiments comprise a motion sensor configured to determine a motion of the electronic device; wherein the processor is further configured to determine the direction of motion of the electronic device based on the motion of the electronic device. Some embodiments comprise an output device configured to report the corrected device direction of the electronic device to a user of the electronic device. Some embodiments comprise a transmitter configured to transmit a signal from the electronic device, wherein the signal represents the corrected device direction of the electronic device. Some embodiments comprise a receiver configured to receive indications of the first and second directions from the electronic device. Some embodiments comprise a transmitter configured to transmit an indication of the corrected device direction to the electronic device. In some embodiments, the electronic device comprises a headset; and the corrected device direction represents an orientation of a head of a wearer of the headset.

In general, in one aspect, an embodiment features a method comprising: determining a first direction of an electronic device; determining a direction of motion of the electronic device; determining a calibration offset angle between the first direction and the direction of motion; determining a second direction of the electronic device subsequent to determining the first direction of the electronic device; and determining a corrected device direction of the electronic device based on the second direction and the calibration offset angle.

Embodiments of the method may include one or more of the following features. In some embodiments, the electronic device comprises a headset; and the corrected device direction represents an orientation of a head of a wearer of the headset. In some embodiments, the electronic device is wearable; the electronic device comprises a don/doff sensor; and one or more of the determining steps is performed only when the don/doff sensor indicates the electronic device is being worn. In some embodiments, determining a direction of motion of the electronic device comprises determining a plurality of locations of the electronic device. In some embodiments, determining a direction of motion of the electronic device comprises determining a motion of the electronic device.

The details of one or more implementations are set forth in the accompanying drawings and the description below. Other features will be apparent from the description and drawings, and from the claims.

### DESCRIPTION OF DRAWINGS

FIG. 1 is an overhead view of a user or wearer of an electronic device.

FIG. 2 shows elements of a communication system according to one embodiment.

FIG. 3 shows elements of a headset according to one embodiment.

FIG. 4 shows elements of a smartphone according to one embodiment.

FIG. 5 shows a process for the communication system of FIG. 2 according to one embodiment.

FIG. 6 shows a process for a single mobile electronic device according to one embodiment.

The leading digit(s) of each reference numeral used in this specification indicates the number of the drawing in which the reference numeral first appears.

### DETAILED DESCRIPTION

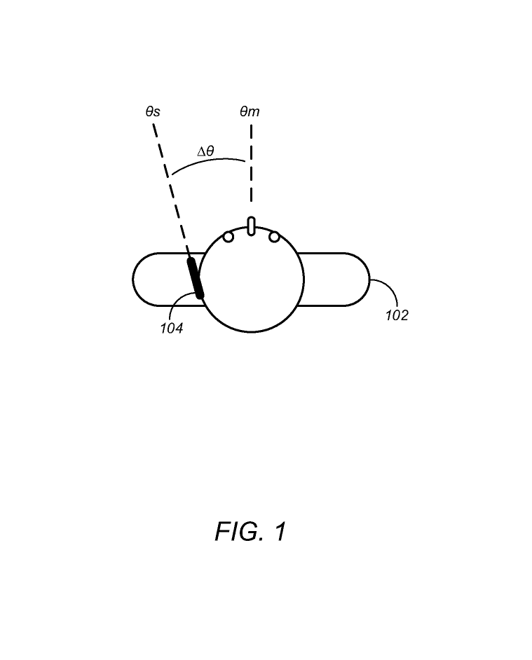

Embodiments of the present disclosure provide automatic determination of user direction based on mobile device direction. FIG. 1 illustrates the techniques discussed herein. FIG. 1 is an overhead view of a person 102, also referred to herein as a “user” of an electronic device or a “wearer” of a wearable electronic device. In the example of FIG. 1, the user 102 is a wearer of a monaural headset 104. However, the techniques disclosed herein also apply to other sorts of headsets and wearables, as well as to non-wearable electronic devices and combinations of the two. Other features are contemplated as well.

Referring to FIG. 1, the headset 104 may include a direction sensor, such as an e-compass or the like, that reports a device direction θs. But because the headset 104 is not perfectly aligned, the device direction θs differs from the user direction θm by a calibration offset angle Δθ (Δθ=θm−θs). For example, if the device direction is north-by-northwest (θs=337.5°) while the calibration offset angle Δθ is 22.5°, the user direction θm is north (θm=360°).

According to various embodiments, the direction of motion θm of the user is used together with the device direction θs to determine the calibration offset angle Δθ. Then the calibration offset angle Δθ is used with subsequent device directions θs to determine the user direction, also referred to herein as the “corrected device direction.” For example, if a subsequent device direction θs is east (θs=90°), then the corrected device direction θc is east-by-southeast (θs+Δθ=90°+22.5°=112.5°).

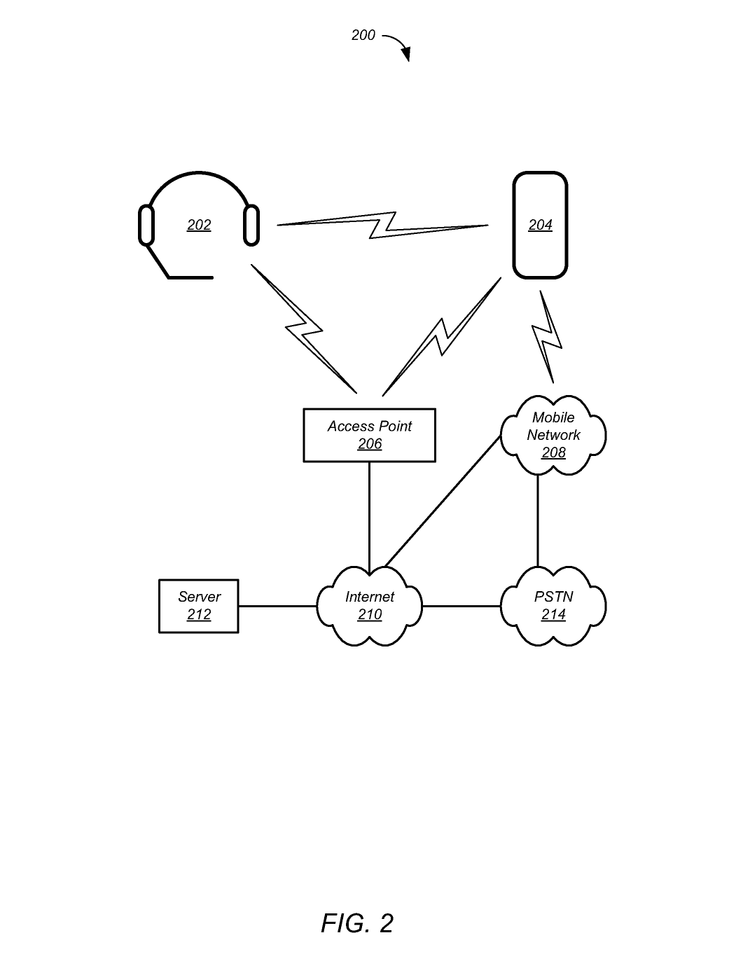

FIG. 2 shows elements of a communication system 200 according to one embodiment. Although in the described embodiment elements of the communication system 200 are presented in one arrangement, other embodiments may feature other arrangements. For example, elements of the communication system 200 may be implemented in hardware, software, or combinations thereof. As another example, various elements of the communication system 200 may be implemented as one or more digital signal processors.

Referring to FIG. 2, the communication system 200 may include a headset 202, a smartphone 204, an access point 206, a mobile network 208, the Internet 210, a server 212, and a public switched telephone network (PSTN) 214. The communication system may include other networks as well, including for example local-area networks and the like. In the example of FIG. 2, the headset 202 is a wireless headset, and so may have a wireless connection to the smartphone 204. However, in other embodiments, the headset 202 may be a wired headset, and so may have a wired connection to the smartphone 204.

The wireless connection between the headset 202 and the smartphone 204 may be of any type. For example, the wireless connection may be a Bluetooth link, a DECT link, or the like. The headset 202 may have a Wi-Fi connection to the access point 206. The smartphone 204 may have a Wi-Fi connection to the access point 206. The access point 206 may be connected to the Internet 210. The smartphone 204 may have a mobile connection to the mobile network 208. The mobile network 208 may be connected to the Internet 210 and to the PSTN 214. The Internet 210 may be connected to the PSTN 214. The server 212 may be connected to the Internet 210.

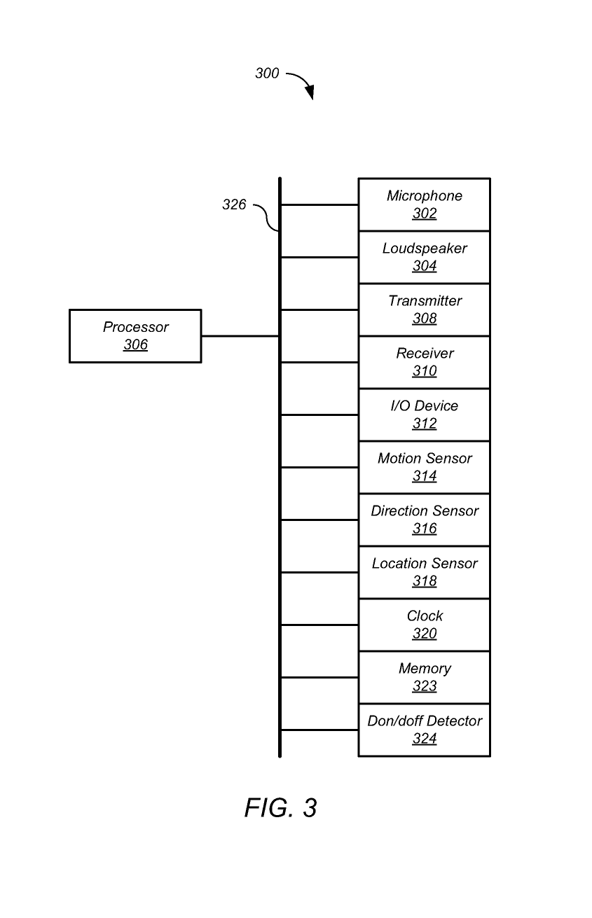

FIG. 3 shows elements of a headset 300 according to one embodiment. The headset 300 may be used to implement the headset 202 of FIG. 2. Although in the described embodiment elements of the headset 300 are presented in one arrangement, other embodiments may feature other arrangements. For example, elements of the headset 300 may be implemented in hardware, software, or combinations thereof.

Referring to FIG. 3, the headset 300 may include one or more microphones 302, a loudspeaker 304, a processor 306, one or more transmitters 308, one or more receivers 310, one or more input/output (I/O) devices 312, a motion sensor 314, a direction sensor 316, a location sensor 318, a clock 320, a memory 322, and a don/doff sensor 324. The headset 300 may include other elements as well. The transmitters 308 and receivers 310 may include wired and wireless transmitters 308 and receivers 310. The elements of the headset 300 may be interconnected by direct connections, by a bus 326, by a combination thereof, or the like. The I/O devices 312 may include any sort of I/O devices, for example such as display devices, haptic devices, buttons, touchscreens, and the like. The motion sensor 314 may include gyroscopes, accelerometers, and the like. The direction sensor 316 may include magnetometers, e-compasses, and the like. The location sensor 318 may employ one or more signals such as GPS signals, Wi-Fi signals, and the like.

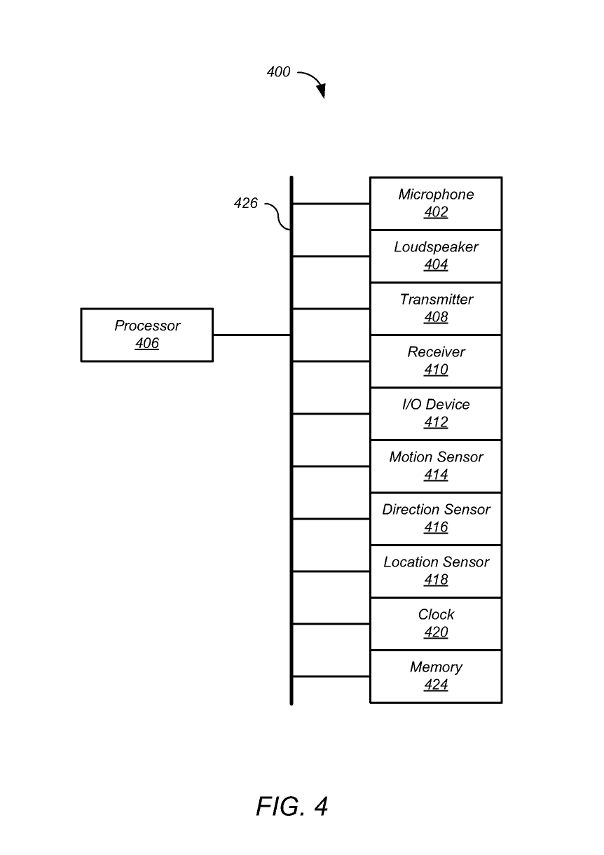

FIG. 4 shows elements of a smartphone 400 of FIG. 2 according to one embodiment. The smartphone 400 may be used to implement the smartphone 204 of FIG. 2. Although in the described embodiment elements of the smartphone 400 are presented in one arrangement, other embodiments may feature other arrangements. For example, elements of the smartphone 400 may be implemented in hardware, software, or combinations thereof.

Referring to FIG. 4, the smartphone 400 may include one or more microphones 402, a loudspeaker 404, a processor 406, one or more transmitters 408, one or more receivers 410, one or more input/output (I/O) devices 412, a motion sensor 414, a direction sensor 416, a location sensor 418, a clock 420, and a memory 422. The smartphone 400 may include other elements as well. The transmitters 408 and receivers 410 may include wired and wireless transmitters 408 and receivers 410. The elements of the smartphone 400 may be interconnected by direct connections, by a bus 426, by a combination thereof, or the like. The I/O devices 412 may include any sort of I/O devices, for example such as display devices, haptic devices, buttons, touchscreens, and the like. The motion sensor 414 may include gyroscopes, accelerometers, and the like. The direction sensor 416 may include magnetometers, e-compasses, and the like. The location sensor 418 may employ one or more signals such as GPS signals, Wi-Fi signals, and the like.

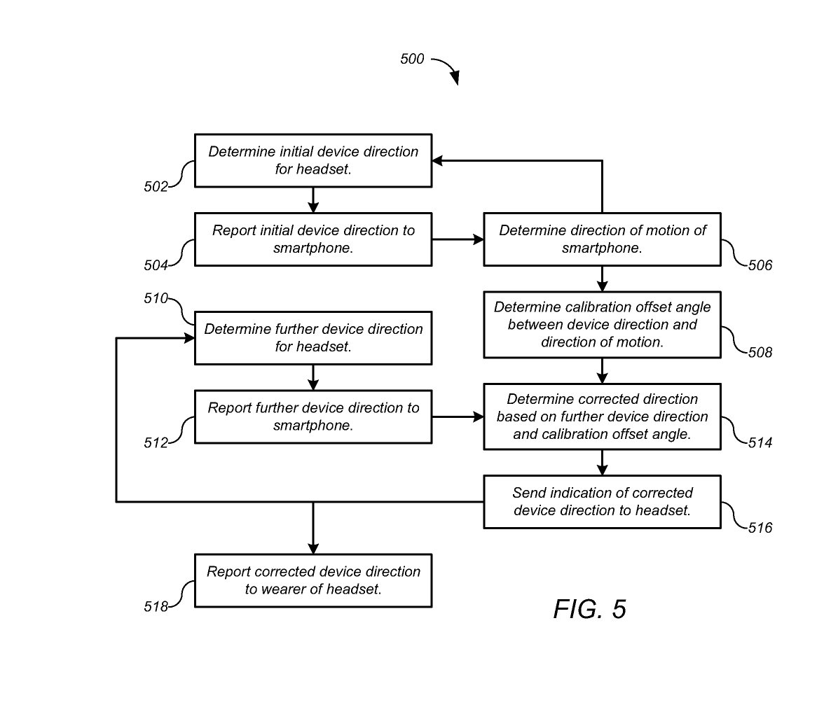

FIG. 5 shows a process 500 for the communication system 200 of FIG. 2 according to one embodiment. Process 500 is also described with reference to the embodiments of FIGS. 3 and 4. Although in the described embodiments the elements of process 500 are presented in one arrangement, other embodiments may feature other arrangements. For example, in various embodiments, some or all of the elements of process 500 may be executed in a different order, concurrently, and the like. Also some elements of process 500 may not be performed, and may not be executed immediately after each other. In addition, some or all of the elements of process 500 may be performed automatically, that is, without human intervention.

In the embodiment of FIG. 5, elements of process 500 are described as being performed by the headset 300 and the smartphone 400, with elements performed by the headset 300 being shown in the left-hand column and elements performed by the smartphone 400 being shown in the right-hand column. However, in other embodiments elements of process 500 may be performed solely by the headset 300, solely by the smartphone 400, solely by another device, or by any combination of these and other elements such as, for example, the server 212.

Referring to FIG. 5, at 502, an initial device direction θs for the headset 300 may be determined. In particular, the direction sensor 316 may indicate a device direction θs. The initial device direction θs may be represented as a compass angle, for example. In some embodiments, the initial device direction θs for the headset 300 may be determined only when the don/doff sensor 324 indicates the headset 300 is being worn.

At 504, the headset 300 may report the initial device direction θs to the smartphone 400. In particular, the transmitter 308 of the headset 300 may transmit a signal representing an indication of the device direction θs. The smartphone 400 may receive the signal. In particular, the receiver 410 of smartphone 400 may receive the signal representing the indication of the device direction θs.

At 506, the processor 406 of the smartphone 400 may determine a direction of motion θm of the smartphone 400. The direction of motion θm may be represented as a compass angle, for example. In some embodiments, the direction of motion θm may be determined based on a plurality of locations of the smartphone 400. For example, the location sensor 418 may determine or report a series of locations of the smartphone 400, and the processor 406 may employ the series to determine the direction of motion θm of the smartphone 400. For example, GPS measurements may be used, and these measurements may include Doppler shift as well. In some embodiments, the direction of motion θm may be determined based on a motion of the smartphone 400. For example, the motion sensor 414 may determine one or more motions of the smartphone 400, and the processor 406 may employ the one or more motions to determine the direction of motion θm of the smartphone 400.

Determination of the initial device direction θs for the headset 300 and the direction of motion θm of the smartphone 400 may be repeated as many times as needed before proceeding further in the process 500 of FIG. 5. The initial device direction θs and the direction of motion θm may be averaged then correlated, correlated then averaged, or any combination thereof. This may take place while a previously-determined calibration offset angle Δθ is employed by the remainder of the process 500. These techniques may be selected so as to compensate for variations in the initial device direction θs and the direction of motion θm caused by running, walking, and the like.

At 508, the processor 406 may determine a calibration offset angle Δθ between the device direction θs and the direction of motion θm, for example as described above. The calibration offset angle Δθ may be stored in the memory 424.

Subsequent to the determination of the initial device direction, at 510, a further device direction θs for the headset 300 may be determined. In particular, the direction sensor 316 may indicate a further device direction θs. The device direction θs may be represented as a compass angle, for example. In some embodiments, the further device direction θs for the headset 300 may be determined only when the don/doff sensor 324 indicates the headset 300 is being worn.

At 512, the headset 300 may report the further device direction θs to the smartphone 400. In particular, the transmitter 308 of the headset 300 may transmit a signal representing an indication of the further device direction θs. The smartphone 400 may receive the signal. In particular, the receiver 410 of the smartphone 400 may receive the signal representing the indication of the further device direction θs. At 514, the processor 406 of the smartphone 400 may determine a corrected device direction θc based on the further device direction θs and the calibration offset angle Δθ, for example as described above.

At 516, the smartphone 400 may send an indication of the corrected device direction θc to the headset 300. In particular, the transmitter 408 of the smartphone 400 may transmit a signal representing an indication of the corrected device direction θc. The headset 300 may receive the signal. In particular, the receiver 310 of the headset 300 may receive the signal representing the indication of the corrected device direction θc. The process 500 may then resume, at 510. At 518, the I/O device 312 of the headset 300 may report the corrected device direction θc to a wearer of the headset 300.

In the process 500 of FIG. 5, the calibration offset angle Δθ may be determined only once, and then used repeatedly. However, in other embodiments, the calibration offset angle Δθ may be determined periodically, and then used repeatedly between determinations of the calibration offset angle Δθ. In still other embodiments, the calibration offset angle Δθ may be determined periodically, and then used only once between determinations of the calibration offset angle Δθ.

The corrected device directions θc have many uses. For example, the corrected device direction θc for a headset 300 represent the orientation of the wearer's head, and so may be used for head tracking. As another example, the corrected device direction θc may be displayed to the wearer by a connected smartphone 400, employed by apps executing on the smartphone 400, and reported to other devices such as the server 212.

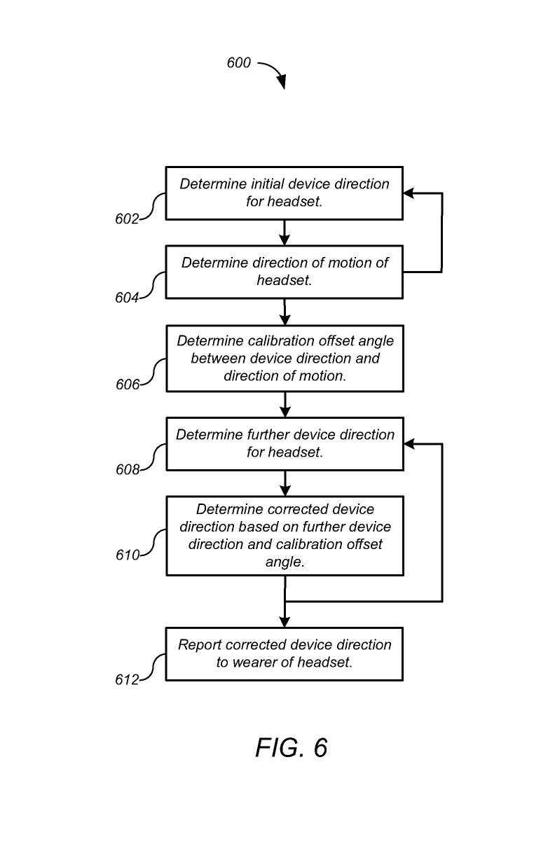

In the process 500 of FIG. 5, multiple devices may cooperate to determine and report a corrected device direction. In other embodiments, this may be accomplished by a single device. FIG. 6 shows a process 600 for such a mobile electronic device according to one embodiment. Process 600 is also described with reference to the headset 300 of FIG. 3. However, the process 600 may be performed by any suitable mobile electronic device, for example such as the smartphone 400 of FIG. 4.

Although in the described embodiments the elements of process 600 are presented in one arrangement, other embodiments may feature other arrangements. For example, in various embodiments, some or all of the elements of process 600 may be executed in a different order, concurrently, and the like. Also some elements of process 600 may not be performed, and may not be executed immediately after each other. In addition, some or all of the elements of process 600 may be performed automatically, that is, without human intervention.

Referring to FIG. 6, at 602, an initial device direction θs for the headset 300 may be determined. In particular, the direction sensor 316 may indicate a device direction θs. The device direction θs may be represented as a compass angle, for example. In some embodiments, the initial device direction θs for the headset 300 may be determined only when the don/doff sensor 324 indicates the headset 300 is being worn.

At 604, the processor 306 of the headset 300 may determine a direction of motion θm of the headset 300. The direction of motion θm may be represented as a compass angle, for example. In some embodiments, the direction of motion θm may be determined based on a plurality of locations of the headset 300. For example, the location sensor 318 may determine or report a series of locations of the headset 300, and the processor 306 may employ the series to determine the direction of motion θm of the headset 300. For example, GPS measurements may be used, and these measurements may include Doppler shift as well. In some embodiments, the direction of motion θm may be determined based on a motion of the headset 300. For example, the motion sensor 314 may determine one or more motions of the headset 300, and the processor 306 may employ the one or more motions to determine the direction of motion θm of the headset 300.

Determination of the initial device direction θs and the direction of motion θm may be repeated as many times as needed before proceeding further in the process 600 of FIG. 6. The initial device direction θs and the direction of motion θm may be averaged then correlated, correlated then averaged, or any combination thereof. This may take place while a previously-determined calibration offset angle Δθ is employed by the remainder of the process 600. These techniques may be selected so as to compensate for variations in the initial device direction θs and the direction of motion θm caused by running, walking, and the like.

At 606, the processor 306 may determine a calibration offset angle Δθ between the device direction θs and the direction of motion θm, for example as described above. The calibration offset angle Δθ may be stored in the memory 324.

Subsequent to the determination of the initial device direction θs, at 608, a further device direction θs for the headset 300 may be determined. In particular, the direction sensor 316 may indicate a further device direction θs. The device direction θs may be represented as a compass angle, for example. In some embodiments, the further device direction θs for the headset 300 may be determined only when the don/doff sensor 324 indicates the headset 300 is being worn.

At 610, the processor 306 of the headset 300 may determine a corrected device direction θc based on the further device direction θs and the calibration offset angle Δθ, for example as described above. The process 600 may then resume, at 608. At 612, the I/O device 312 of the headset 300 may report the corrected device direction θc to a wearer of the headset 300.

In the process 600 of FIG. 6, the calibration offset angle Δθ may be determined only once, and then used repeatedly. However, in other embodiments, the calibration offset angle Δθ may be determined periodically, and then used repeatedly between determinations of the calibration offset angle Δθ. In still other embodiments, the calibration offset angle Δθ may be determined periodically, and then used only once between determinations of the calibration offset angle Δθ.

In some cases a user may be sitting in a rear-facing or side-facing seat on a bus, train or the like. This could produce false or misleading measurements. According to some embodiments, motion and direction may be regularly updated. In addition, the context may be recognized. For example, walking, running, and riding a bike may be distinguished from riding in a vehicle based on motion (for example repetitive bumpy motion for walking and running) and speed (bike versus bus). In some embodiments, location awareness is employed. For example, Wi-Fi access point ID may be used to determine the user is in public transportation, or a Bluetooth low-energy proximity sensor/beacon may be used to indicate the user is on a bike. This information can then be used to halt or enable calibration. For example, calibration may be enabled for a bike, but disabled for public transportation.

In some embodiments, the device motion θm may be determined using an accelerometer. For example, for the case of a headset with an accelerometer and angle tracking magnetometer, assume the direction measuring device reports 0 degrees with respect to the device body x-axis when the headset points north, and positive 90 degrees when north is along the device body y-axis. As an example, when roughly equal positive average accelerations are detected in the device body coordinate system along x and y, it can be concluded that the user is moving in the 45-degree direction.

Various embodiments of the present disclosure may be implemented in digital electronic circuitry, or in computer hardware, firmware, software, or in combinations thereof. Embodiments of the present disclosure may be implemented in a computer program product tangibly embodied in a computer-readable storage device for execution by a programmable processor. The described processes may be performed by a programmable processor executing a program of instructions to perform functions by operating on input data and generating output. Embodiments of the present disclosure may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language, or in assembly or machine language if desired; and in any case, the language may be a compiled or interpreted language. Suitable processors include, by way of example, both general and special purpose microprocessors. Generally, processors receive instructions and data from a read-only memory and/or a random access memory. Generally, a computer includes one or more mass storage devices for storing data files. Such devices include magnetic disks, such as internal hard disks and removable disks, magneto-optical disks; optical disks, and solid-state disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, ASICs (application-specific integrated circuits). As used herein, the term “module” may refer to any of the above implementations.

A number of implementations have been described. Nevertheless, various modifications may be made without departing from the scope of the disclosure. Accordingly, other implementations are within the scope of the following claims.

What is claimed is:

1. A wearable electronic device comprising:
a direction sensor configured to determine directions of the electronic device; and
a transmitter configured to transmit indications of the directions;
wherein a calibration offset angle is determined between one of the directions of the electronic device and a direction of motion of the electronic device; and
wherein a corrected device direction of the electronic device is determined based on the calibration offset angle and a subsequent direction of the electronic device.

2. The wearable electronic device of claim 1, further comprising:
a receiver configured to receive an indication of the corrected device direction of the electronic device; and
an output device configured to report the corrected device direction of the electronic device to a user of the electronic device.

3. The wearable electronic device of claim 1, wherein:
the wearable electronic device comprises a headset; and
the corrected device direction represents an orientation of a head of a wearer of the headset.

4. The wearable electronic device of claim 1, further comprising:
a don/doff sensor configured to indicate when the wearable electronic device is being worn;
wherein the calibration offset angle and the corrected device direction are determined based only on directions determined by the direction sensor when the wearable electronic device is being worn.

5. The wearable electronic device of claim 1, further comprising:
a location sensor configured to determine a plurality of locations of the wearable electronic device; and
a processor configured to determine the direction of motion of the wearable electronic device based on the plurality of locations of the wearable electronic device.

6. The wearable electronic device of claim 1, further comprising:
a motion sensor configured to determine a motion of the wearable electronic device; and
a processor configured to determine the direction of motion of the wearable electronic device based on the motion of the wearable electronic device.

7. An apparatus comprising:
a processor configured to
(i) determine a direction of motion of an electronic device;
(ii) determine a calibration offset angle between the direction of motion and a first direction of the electronic device; and
(iii) determine a corrected device direction of the electronic device based on the calibration offset angle and a second direction of the electronic device, wherein the second direction is determined subsequent to the first direction being determined.

8. The apparatus of claim 7, further comprising:
a direction sensor configured to determine the first and second directions of the electronic device.

9. The apparatus of claim 7, further comprising:
a location sensor configured to determine a plurality of locations of the electronic device;
wherein the processor is further configured to determine the direction of motion of the electronic device based on the plurality of locations of the electronic device.

10. The apparatus of claim 7, further comprising:
a motion sensor configured to determine a motion of the electronic device;
wherein the processor is further configured to determine the direction of motion of the electronic device based on the motion of the electronic device.

11. The apparatus of claim 7, further comprising:
an output device configured to report the corrected device direction of the electronic device to a user of the electronic device.

12. The apparatus of claim 7, further comprising:
a transmitter configured to transmit a signal from the electronic device, wherein the signal represents the corrected device direction of the electronic device.

13. The apparatus of claim 7, further comprising:
a receiver configured to receive indications of the first and second directions from the electronic device.

14. The apparatus of claim 7, further comprising:
a transmitter configured to transmit an indication of the corrected device direction to the electronic device.

15. The apparatus of claim 7, wherein:
the electronic device comprises a headset; and
the corrected device direction represents an orientation of a head of a wearer of the headset.

16. A method comprising:
determining a first direction of an electronic device;
determining a direction of motion of the electronic device;
determining a calibration offset angle between the first direction and the direction of motion;
determining a second direction of the electronic device subsequent to determining the first direction of the electronic device; and
determining a corrected device direction of the electronic device based on the second direction and the calibration offset angle.

17. The method of claim 16, wherein:
the electronic device comprises a headset; and
the corrected device direction represents an orientation of a head of a wearer of the headset.

18. The method of claim 16, wherein:
the electronic device is wearable;
the electronic device comprises a don/doff sensor; and
one or more of the determining steps is performed only when the don/doff sensor indicates the electronic device is being worn.

19. The method of claim 16, wherein:
determining a direction of motion of the electronic device comprises determining a plurality of locations of the electronic device.

20. The method of claim 16, wherein:
determining a direction of motion of the electronic device comprises determining a motion of the electronic device.
